(19) United States
(12) Patent Application Publication
(10) Pub. No.: US 2020/0004221 A1
(43) Pub. Date: Jan. 2, 2020

(54) METHOD AND SYSTEM FOR TOOL LIFE MONITORING AND MANAGEMENT IN A CNC ENVIRONMENT

(71) Applicant: Siddhant Sarup, Ludhiana, Punjab (IN)

(72) Inventors: Siddhant Sarup, Ludhiana, Punjab (IN); Gaurav Sarup, Ludhiana, Punjab (IN); Prashant Sarup, Ludhiana, Punjab (IN)

(21) Appl. No.: 16/486,526

(22) PCT Filed: Feb. 23, 2018
(86) PCT No.: PCT/IN2018/050096

§ 371 Date: Aug. 16, 2019

(30) Foreign Application Priority Data
Feb. 25, 2017 (IN) 201711002831

(51) Int. Cl. G05B 19/4065; G05B 23/02; B23Q 17/09

(52) U.S. Cl. CPC G05B 19/4065; B23Q 17/0909; B23Q 17/0995; G05B 23/0283

(57) ABSTRACT

The present invention provides a system and a method for tool life management and monitoring in a CNC environment. The invention employs an indirect method that measures tool wear effect on size change of jobs. After every measurement of the job, the tool wear is calculated by a set of advanced algorithms and this value is sent to a file where it adds to a previous value. When the sum of all these tool wear values equals that of the maximum allowable wear for that type of tool insert, a signal is generated to indicate that tool insert life is over and it should be replaced. Advantageously, the invention ensures that life of each edge of the insert is fully utilized and also identifies when an edge is worn out (its useful life is over).

### FIELD OF INVENTION

The present invention relates to computerized numerical control (CNC) machines and in particularly relates to method and system for management and monitoring of a tool life in a CNC environment.

### BACKGROUND OF INVENTION

The performance of a cutting tool in machine tools and manufacturing processes is the most critical to productivity, as stated in Iron Age, Jul. 27, 1981 “Does Adaptive Control Still Promise Improved Productivity” by Raymond J. Larsen, pp. 57-68. In particular, a reliable tool breakage detection system is essential to avoid loss of cutting tolerances, overload and catastrophic failure. Attempts have been made to follow the tool deterioration process, either by direct viewing techniques, by reference to models, or even by material exploration for possible internal flaws.

The optimization and monitoring the performance of the tool and the tool insert are essential to avoid circumstances of early tool wear and maximize the usage of tool insert. The monitoring of the tool inserts is generally dependent on the operator of the machine. The operator usually judges from either the condition/surface finish of job that the tool insert is providing to the job or change in sound during machining the job. However, this seems to be the most unreliable method leading to either wastage of good inserts or accidents on machine if an insert is kept running even when it is past its working life.

Another conventional method for monitoring and optimizing a tool insert life is determining an estimate based on range of tool insert life achieved in its past operations and then setting a parameter in the CNC to give an alarm when the tool insert life has reached its set life, which may be set, generally, at 5-10% lower than the lowest in the range. For an instance, if the past records show that one tool insert edge is giving 80-120 jobs/edge, then optimized life set in the machine may be 75. This method is generally wasteful as tool inserts that are good for many more jobs are discarded. Occasionally, it can be dangerous as the tool insert may have got blunted by excessively hard material (say after 60 jobs) but will continue to be used and will get broken and cause accident. Both these methods are wasteful and dangerous for the machine.

Therefore, there exists a long felt need for an improved automated system for tool insert life monitoring and management.

### SUMMARY OF INVENTION

With modern production automation, flexibility and degree of integration of continuous improvement to ensure the machining accuracy of the work piece, surface quality, safety equipment and a reasonable use of the tool, the tool life must be real-time monitored and effective management. Therefore, it is an objective of the present invention to provide a method and an apparatus for real-time monitoring of tool and tool inserts is to ensure that life of each edge of the insert is fully utilized.

An object of the present invention is to identify when a tool insert edge is worn out which indicated that its useful life is over.

An object of the present invention is to provide an improved automated system for tool insert monitoring and management.

An object of the present invention is to measure the effect of tool wear on change of size of the job.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 shows a flow chart for a method for monitoring and managing a tool insert life in accordance with an embodiment of the present invention; and

FIG. 2 shows a block diagram of a system monitoring and managing a tool insert life in accordance with an embodiment of the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying drawings.

The invention relates to monitoring of tool wear rate and tool-failure. The present invention provides an automated method and system for real time monitoring of tool and tool-insert to ensure that each edge of the tool insert is fully utilized till its full life. The system and method identifies when an edge of the tool insert is worn out and its useful life is over. The automated method measures the tool wear by an ‘indirect method’, i.e. measuring the effect of tool wear on size change of the job. As a job is put under a machining process, the tool with its tool insert performs cutting and machining operations on it, which in turn changes the size of the job. During the process, the size of the job is measured intermittently. This is referred to as ‘measurement data’ related to job.

After every measurement of the job, the tool wear is calculated by advanced algorithms. This value is sent and stored onto a file where the value adds up to previously calculated value. When the sum of all these tool wear values equals that of the maximum allowable wear for that type of tool insert, a signal is generated to indicate that the life of that tool insert is over and it should be replaced. Thereafter, the system asks the CNC to replace the worn out tool with a ‘Sister’ Tool i.e. a tool which is identical to the worn out tool. Therefore, the present method and system ensures that the machining productions continue un-interrupted till the entire sister tools are worn out.

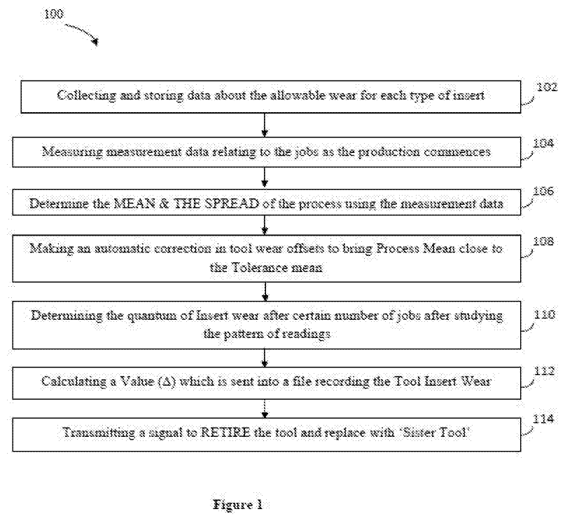

Referring to FIG. 1, a flow chart for a method 100 for monitoring and managing a tool insert life is illustrated, in accordance with an embodiment of the present invention. The method 100 includes a step 102 of collecting and storing data about an allowable wear for a type of tool insert, before it is considered unfit for further use. It may be apparent to a person skilled in the art that the method may also involve collecting the allowable wear limit for more than one type of tool inserts used in a machining process. The data for the allowable wear limits may be measured using any standard mechanisms including digital mechanisms having lasers. This data may be referred to as allowable wear limit, abbreviated as AWL for the purposes of this disclosure.

Thereafter, as the manufacturing process commences with its operation, the size of the job changes and these changes in the size are measured on a gauging station intermittently. These readings of the job size changes are referred to as ‘measurement data’, which is regularly recorded on the gauging station, at step 104. Further, at a step 106, the method employs its advanced algorithms to determine a MEAN and a SPREAD of the process (as per Normal Distribution Bell Curve) using the measurement data. A correction is automatically made in tool wear offsets to bring Process Mean close to a Tolerance mean, in a further step 108.

As the manufacturing progresses, the job size varies randomly within the limits determined by its process capability. For an instance, 99.76% of the job size readings recorded on the gauging station will fall in a range between Mean±3σ, where σ is standard deviation. Therefore, any reading falling within this range is considered as normal. In a stable turning (or manufacturing) process, any deviation occurring in the process mean is caused due to tool insert wear. Because of this, the mean tends to shift in one direction (outer diameter getting oversized and inner diameter getting undersized).

The continuous changes in the job size generate a pattern of readings indicating size change of the job in a particular pattern. For a particular tool insert, this pattern of readings is analyzed for every job that goes under that tool insert. Therefore, a quantum (or a discrete value) of tool insert wear is determined in a step 110 applying a set of advanced algorithms, after that tool insert has worked on a certain number of jobs, and the pattern of readings for those jobs is studied, essentially determining in the pattern, where this variation is normal and is because of tool insert wear. Hence, the method 100 calculates the discrete value (Δ) for the tool insert wear, which is further sent and recorded into a file saving the Tool Insert Wear, in a next step 112.

As the manufacturing progresses, a number of discrete values are stored in the file, and with every new discrete value generated, the new value adds up to the previously stored discrete value of the tool insert wear. Consequently, when the sum of all these Δ values, i.e. ΣΔ becomes equal to the value of AWL, a signal is sent to retire the tool. Further, it is also signaled to replace the retired tool with a ‘Sister Tool’, in a step 114. Data pertaining to number of job pieces produced by each tool insert edge is stored in a folder that can be used to achieve reduction in tool cost.

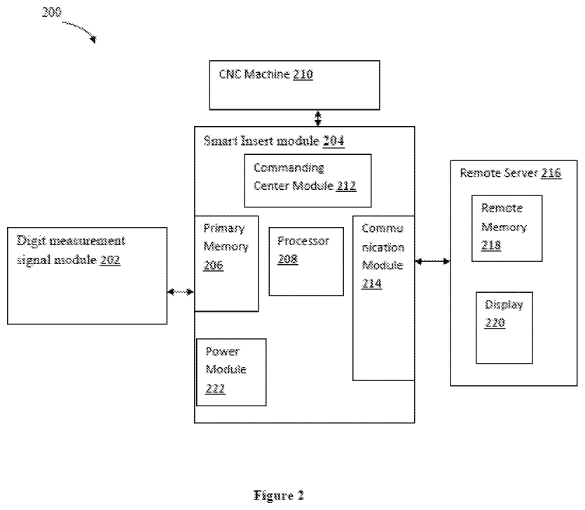

Referring to FIG. 2, a block diagram for a system 200 for monitoring and managing a tool insert life is illustrated, in accordance with an embodiment of the present invention. The system 200 includes a digit measurement signal module 202 that is configured for collecting and storing a data about the allowable wear for each type of insert (before it is considered unfit for further use). This data may be referred to as allowable wear limit, abbreviated as AWL for the purposes of this disclosure. The data is transmitted to a smart insert module 204 and is stored in the smart insert primary memory 206. The smart insert module works in conjunction with the CNC machine 210.

As the production progresses, the job experiences size changes, and these changes are measured by the system 200. This is referred to as ‘measurement data’ relating to the jobs, which is measured by the digit measurement signal module 202 (or a gauging station) and transmitted to the smart insert module 204. Further, the measurement data is processed by a smart insert processor 208 to determine a MEAN and SPREAD of the manufacturing process (as per Normal Distribution—Bell Curve). The smart insert processor 208 executes a set of advanced algorithms to determine the mean and spread of the process. A correction is also automatically made in tool wear offsets to bring the process mean close to the tolerance mean, by the processor 208.

As the manufacturing progresses, the job size varies randomly within the limits determined by its process capability. For an instance, 99.76% of the job size readings recorded on the gauging station will fall in a range between Mean±3σ, where σ is standard deviation. Therefore, any reading falling within this range is considered as normal. In a stable turning (or manufacturing) process, any deviation occurring in the process mean is caused due to tool insert wear. Because of this, the mean tends to shift in one direction (outer diameter getting oversized and inner diameter getting undersized).

The continuous changes in the job size generate a pattern of readings indicating size change of the job in a particular pattern. For a particular tool insert, this pattern of readings is analyzed for every job that goes under that tool insert. Therefore, a quantum of too insert wear is determined by the smart insert processor 208 using its advanced algorithms, after that tool insert has worked on a certain number of jobs, and the pattern of readings for those jobs is studied, essentially determining in the pattern, where this variation is normal and is because of tool insert wear. Resultantly, a discrete value (Δ) is calculated and is sent into a file recording the tool insert wear. Hence, a number of discrete values are stored in the file, and with every new discrete value generated, the new value adds up to the previously stored discrete value of the tool insert wear. Consequently, when the sum of all these Δ values, i.e. ΣΔ becomes equal to the value of AWL, a signal is sent to RETIRE the tool, and replace with a ‘Sister Tool’, to the CNC machine 210 using the command centre module 212.

Further, a data pertaining to number of pieces produced by each tool insert edge is stored in a folder that can be used to achieve reduction in tool cost. The data is transmitted from a communication module 214 to a remote server 216 for storage and further actions. The storage may be in a local memory or stored in cloud or memory 218 of a remote server 216 having a display 220. The display may be used for displaying the measurement and log related details. A power module 222 is further provided in the smart insert module 204 for powering one or more parts of the smart insert module 204.

The present invention may be implemented using a typical hardware configuration of a computer system. The computer system can include a set of instructions that can be executed to cause the computer system to perform any one or more of the methods disclosed. The computer system may operate as a standalone device or may be connected, e.g., using a network, to other computer systems or peripheral devices.

Advantageously, the present invention provides a system and a method for monitoring and managing tool insert life. The invention ensures that each edge of the tool insert is fully utilized till its full life, by employing an indirect method of measuring the effect of tool wear on the size change of job. The invention also signals the machine when a tool insert is fully utilized and to use a sister tool. Further, the invention also generates a data related to the number of job pieces a tool insert edge has produced, which is used to achieve reduction in tool cost too.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A system for monitoring and managing a tool insert life in a machining process, the system comprising:
a digit measurement signal module configured for collecting and storing data representing an allowable wear limit for the tool insert; and
for measuring a set of measurement data indicating changes in size of plurality of jobs as the machining process commences; and
a smart insert module configured for
receiving the allowable wear limit and the measurement data from the digit measurement signal module;
determining a mean and a spread of the machining process from the measurement data;
determining any deviations in the mean during the machining process of the jobs, where the deviation is caused by wear in the tool insert and is indicative of the tool insert wear;
determining a plurality of discrete values of the tool insert wear after a number of jobs operated by the tool insert and analyzing a pattern of readings relating to the size changes those job;
recording the discrete values of the tool wear insert;
determining a sum of the plurality of discrete values of the tool wear insert and comparing the sum with the allowable wear limit; and
indicating for retiring the tool, if the sum is equal to the allowable wear limit.

2. The system as claimed in claim 1, wherein the smart insert module further indicates a CNC machine to replace the tool with a ‘Sister Tool’, when the sum is equal to the allowable wear limit.

3. The system as claimed in claim 1, wherein the smart insert module automatically corrects offsets in tool wear to bring the mean close to a tolerance mean.

4. The system as claimed in claim 1, wherein the smart insert module comprises a smart processor that executes a set of advanced algorithms to determine the mean and spread of the process and also the discrete values of the tool insert wear; and a memory for storing the data related to the process and the tool insert.

5. The system as claimed in claim 4, wherein a data pertaining to a number of finished jobs produced by each tool insert edge is stored in the memory that can further be used for reduction in tool costs.

6. The system as claimed in claim 5, wherein the data pertaining to the number of finished jobs is transmitted from the smart insert module to a remote server for storage and further actions, where the remote server has a display.

7. The system as claimed in claim 6, wherein the storage may be done in a local memory or stored in cloud or memory of the remote server.

8. A method for monitoring and managing a tool insert life in a machining process, the method comprising the steps of:
collecting and storing data representing an allowable wear limit for the tool insert; and measuring a set of measurement data indicating changes in size of plurality of jobs as the machining process commences, by a digit measurement signal module;
configuring a smart insert module to execute the following steps of:
receiving the allowable wear limit and the measurement data from the digit measurement signal module;
determining a mean and a spread of the machining process from the measurement data;
determining any deviations in the mean during the machining process of the jobs, where the deviation is caused by wear in the tool insert and is indicative of the tool insert wear;
determining a plurality of discrete values of the tool insert wear after a number of jobs operated by the tool insert and analyzing a pattern of readings related to size changes of those jobs;
recording the discrete values of the tool wear insert;
determining a sum of the plurality of the discrete values of the tool wear insert and comparing the sum with the allowable wear limit; and
indicating for retiring the tool, if the sum is equal to the allowable wear limit.

9. The method as claimed in claim 8, wherein the smart insert module further indicates a CNC machine to replace the tool with a ‘Sister Tool’, when the sum is equal to the allowable wear limit.

10. The method as claimed in claim 8, wherein the smart insert module automatically corrects offsets in tool wear to bring the mean close to a tolerance mean.

11. The method as claimed in claim 8, wherein the smart insert module comprises a smart processor that executes a set of advanced algorithms to determine the mean and spread of the process and also the discrete values of the tool insert wear; and a memory for storing the data related to the process and the tool insert.

12. The method as claimed in claim 11, wherein a data pertaining to a number of finished jobs produced by each tool insert edge is stored in the memory that can further be used for reduction in tool costs.

13. The method as claimed in claim 12, wherein the data pertaining to the number of finished jobs is transmitted from the smart insert module to a remote server for storage and further actions, where the remote server has a display.
